(19) United States
(12) Patent Application Publication
(10) Pub. No.: US 2015/0145781 A1
(43) Pub. Date: May 28, 2015

(54) DISPLAYING A PANEL OVERLAY ON A COMPUTING DEVICE RESPONSIVE TO INPUT PROVIDED THROUGH A TOUCH-SENSITIVE HOUSING

(71) Applicant: KOBO INC., Toronto (CA)

(72) Inventors: Damian Lewis, Toronto (CA); James Wu, Newmarket (CA); Robin Bennett, Beeton (CA)

(73) Assignee: KOBO INC., Toronto (CA)

(21) Appl. No.: 14/088,170

(22) Filed: Nov. 22, 2013

(51) Int. Cl. G09G 5/377; G06F 1/16; G06F 3/041

(52) U.S. Cl. CPC G09G 5/377; G06F 3/041; G06F 1/1626; G06F 1/1692; G09G 2380/14; G09G 2354/00; G09G 2340/12
USPC 345/173

(57) ABSTRACT

A computing device that can interpret touch input provided on a housing of the computing device in order to draw or otherwise provide one content panel relative to another content panel.

### TECHNICAL FIELD

Examples described herein relate to a computing device that displays a panel overlay that is responsive to input provided through a touch-sensitive housing.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose-built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications that enable the user to access an online media library. In this context, the user accounts can enable the user to receive the full benefit and functionality of the device.

### BRIEF DESCRIPTION OF THE DRAWINGS

FIG. 1 illustrates a system for providing e-book services, according to an embodiment.

FIG. 2 illustrates an example of an e-reader device or other electronic personal display device, for use with one or more embodiments described herein.

FIG. 3 is a frontal view of e-reader device 100, according to an embodiment.

FIG. 4 illustrates an e-reader system for displaying a panel over a content region of a display screen in connection with touch input provided on a housing of a personal display device, according to one or more embodiments.

FIG. 5 illustrates a method for displaying a panel overlay responsive to touch input, according to one or more embodiments.

FIG. 6A through FIG. 6C illustrate examples of display states of a screen for a personal display device, in accordance with one or more embodiments.

FIG. 7 illustrates an example of an e-book device that is operated by the user to trigger a panel display that overlays an e-book page.

### DETAILED DESCRIPTION

Examples described herein include a computing device that can interpret touch input provided on a housing of the computing device in order to draw or otherwise provide a panel overlay relative to a content screen. In particular, a computing device can transition a panel to superimpose, overlay or otherwise appear relative to a content screen in a manner that is responsive to touch input provided on a housing of the computing device.

In an aspect, a computing device is provided having a housing, a display assembly that includes a screen, a touch sensor, and one or more processor. The touch sensor is provided within a portion of the housing. The one or more processors operate to display a first content in a content region. Additionally, the one or more processors respond to touch input, detected through the touch sensor, to display at least a portion of a panel concurrently with a portion of the content region.

As used herein, a “panel” refers to a representation of a display area on which content is provided. In some examples, a panel can be provided as a cohesive display region that can be manipulated with input. In particular, some embodiments provide for a panel to be superimposed, overlaid, or otherwise provided concurrently with a content region (e.g., application screen). By way of example, a content region can be used to display content such as a page from an e-book, and the panel can display a home screen or menu screen.

In some embodiments, the processor detects an aspect of the touch input, and displays at least the portion of the panel with a characteristic that is based on the detected aspect of the touch input. By way of example, the processor can detect a direction of the touch input, and draw the panel over the content region in a direction that coincides with the detected direction of the touch input.

In one implementation, the one or more processors respond to the touch input by directionally transitioning the panel over at least the portion of the content region so as to simultaneously reveal more of the panel while concealing more of the content region.

Still further, one implementation provides that the panel provides user-interface features, such as selectable icons or input fields. For example, the panel can coincide with a dedicated graphic user interface that can be superimposed or overlaid onto a region on which content (e.g., page of an e-book) is provided. Among other benefits, examples as described enable a computing device to be physically configured in a manner that avoids the need for conventional approaches for providing user-interface features. For example, in the context of e-reader devices, some conventional approaches utilize basic mechanical buttons or switches to enable basic user-interface functionality. These additional mechanical features often require real-estate on the device housing. Examples described herein reduce or eliminate the need for the housing to carry buttons or other input mechanisms. Moreover, a panel such as described can be triggered into place with minimal distraction to the user's viewing of the content (e.g., thus, for example, enhancing e-reading activity). For example, the panel overlay can enable a home screen application that appears while maintaining the text content present on the screen, so as to avoid the user losing, for example, their place or direction.

Among other benefits, examples described herein enable a personal display device such as an e-reader device to be equipped with sensors that enable a user to transition through pages of an e-book in a manner that mimics how users flip through the pages of a paperback.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

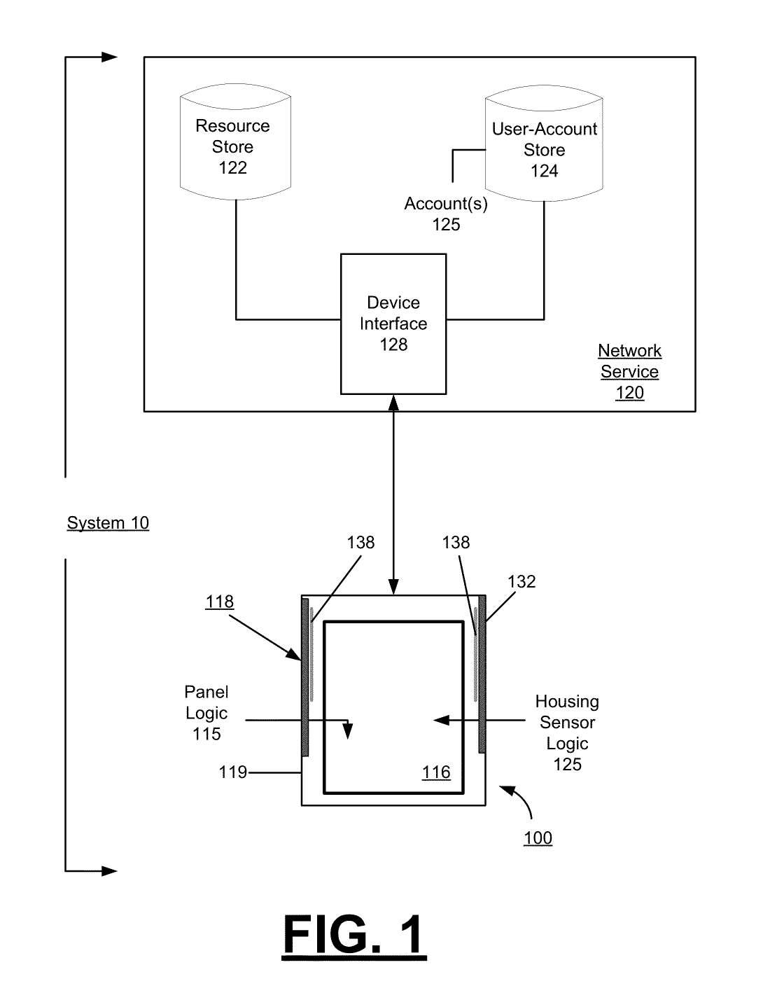

FIG. 1 illustrates a system for providing e-book services, according to an embodiment. In an example of FIG. 1, system 10 includes an electronic display device, shown by way of example as an e-reader device 100, and a network service 120. The network service 120 can include multiple servers and other computing resources that provide various services in connection with one or more applications that are installed on the e-reader device 100. By way of example, in one implementation, the network service 120 can provide e-book services which communicate with the e-reader device 100. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 100 can correspond to any electronic personal display device on which applications and application resources (e.g., e-books, media files, documents) can be rendered and consumed. For example, the e-reader device 100 can correspond to a tablet or a telephony/messaging device (e.g., smart phone). In one implementation, for example, e-reader device 100 can run an e-reader application that links the device to the network service 120 and enables e-books provided through the service to be viewed and consumed. In another implementation, the e-reader device 100 can run a media playback or streaming application that receives files or streaming data from the network service 120. By way of example, the e-reader device 100 can be equipped with hardware and software to optimize certain application activities, such as reading electronic content (e.g., e-books). For example, the e-reader device 100 can have a tablet-like form factor, although variations are possible. In some cases, the e-reader device 100 can also have an E-ink display.

In additional detail, the network service 120 can include a device interface 128, a resource store 122 and a user account store 124. The user account store 124 can associate the e-reader device 100 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 100 may be associated with the user account 125, and multiple devices may be associated with the same account. As described in greater detail below, the e-reader device 100 can store resources (e.g., e-books) that are purchased or otherwise made available to the user of the e-reader device 100, as well as to archive e-books and other digital content items that have been purchased for the user account 125, but are not stored on the particular computing device.

With reference to an example of FIG. 1, e-reader device 100 can include a display screen 116 and a housing 118. In an embodiment, the display screen 116 is touch-sensitive, to process touch inputs including gestures (e.g., swipes). Additionally, the housing 118 can be integrated with touch sensors 138 to provide one or more touch sensing regions 132. In example of FIG. 1, the touch sensing regions 132 are provided on one or more sidewalls 119 of the housing 118. In one implementation, the touch-sensing regions 132 can correspond to a strip of the housing 118 that occupies a portion of an overall length of the housing sidewall 119.

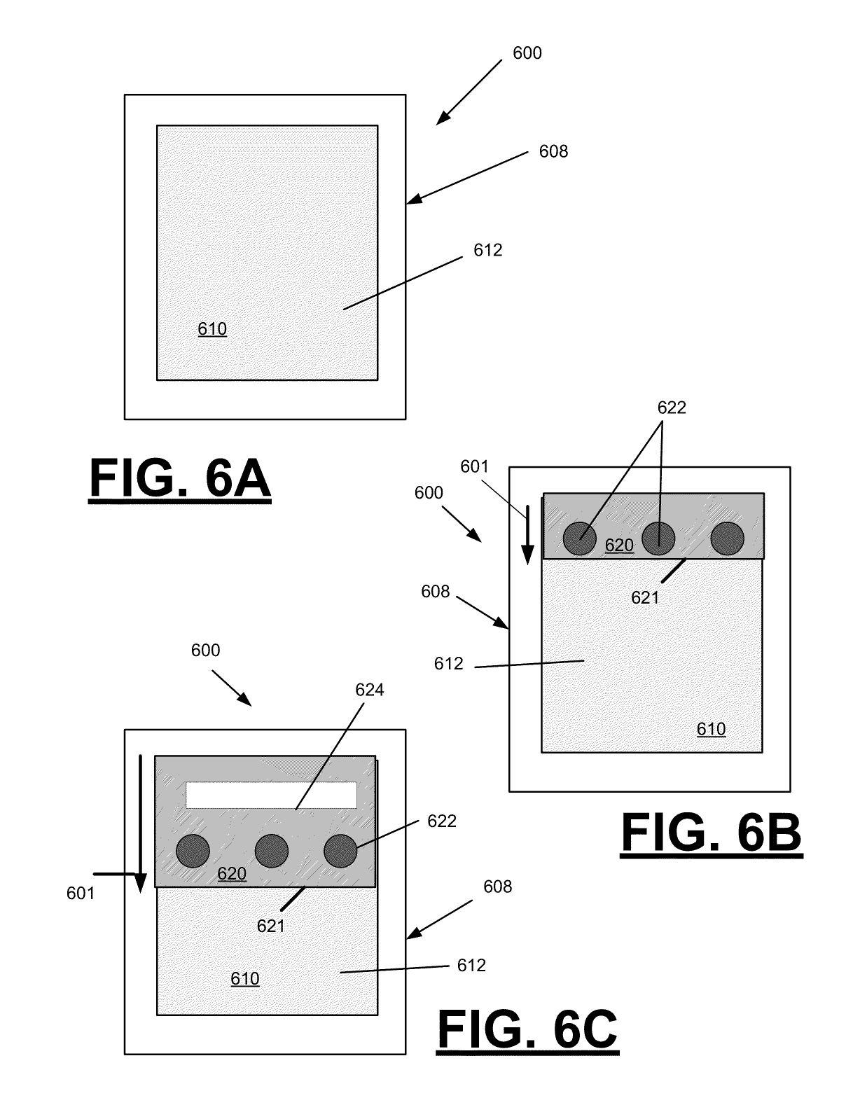

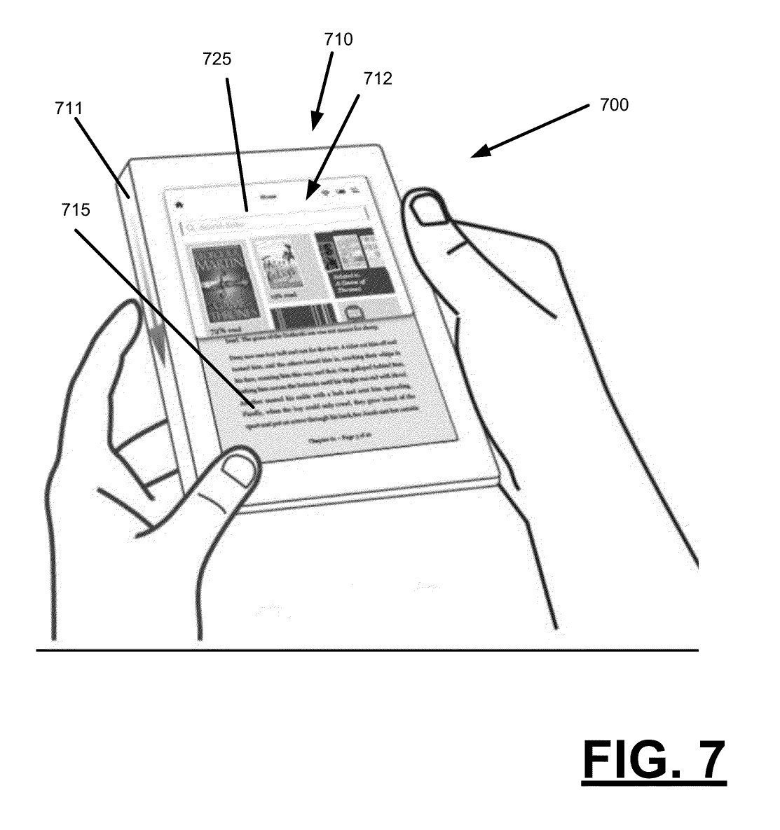

In some embodiments, the e-reader device 100 includes features for providing and enhancing functionality related to displaying paginated content. Among the features, the e-reader device 100 can include panel logic 115 that can present a panel over a content region provided on the display screen 116. The panel logic 115 can include logic that transitions a panel over a content region in a manner that is responsive to touch-input detected at the housing sensing regions 132. Examples such as provided with FIG. 6A through FIG. 7 illustrate how a panel can be superimposed or overlaid onto a content region in response to user input. Among other benefits, the panel can be superimposed in a manner that does not detract the user's attention from a content region provided on the display. For example, the user can interact with the computing device by touching a sidewall 119 of the device, and a resulting panel can be drawn over a portion of the content region, so that the viewer can view both the portion of the content region and the panel at the same time.

Hardware Description

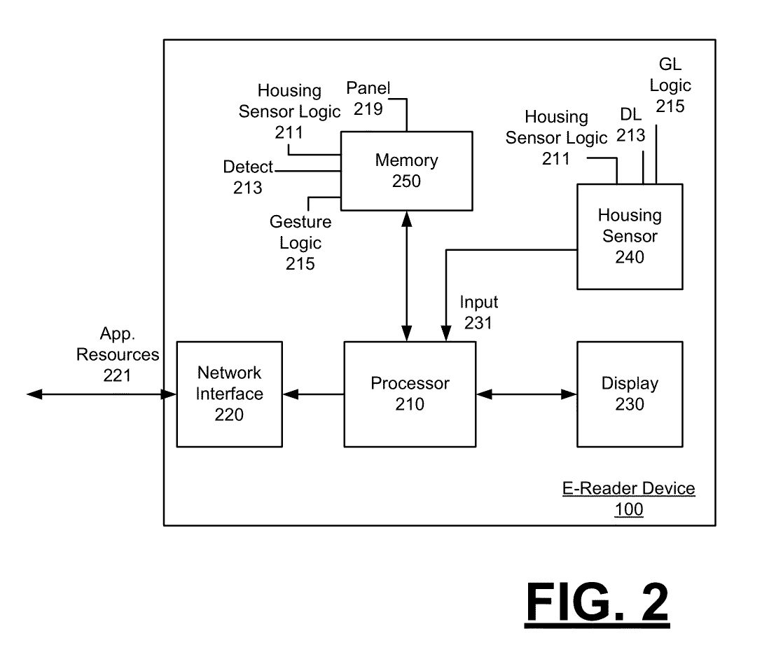

FIG. 2 illustrates an example of an e-reader device or other electronic personal display device, for use with one or more embodiments described herein. In an example of FIG. 2, an e-reader device 100 can correspond to, for example, a device, such as also shown by an example of FIG. 1. With reference to FIG. 2, e-reader device 100 includes a processor 210, a network interface 220, a display 230, one or more housing sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 100 can access the network service 120 to receive various kinds of resources (e.g., digital content items such as e-books, configuration files, account information), as well as to provide information (e.g., user account information, service requests etc.). For example, e-reader device 100 can receive application resources 221, such as e-books or media files, that the user elects to purchase or otherwise download from the network service 120. The application resources 221 that are downloaded onto the e-reader device 100 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the housing sensor components 240, the display 230 or other input mechanisms (e.g., buttons, keyboard, microphone, etc.). With reference to examples described herein, the processor 210 can respond to input 231 from the housing sensor components 240. In some embodiments, the e-reader device 100 includes housing sensor logic 211 that monitors for touch input provided through the housing sensor component 240, and further processes the input as a particular input or type of input. In one implementation, the housing sensor logic 211 can be integrated with the housing sensor. For example, the housing sensor component 240 can be provided as a modular component that includes integrated circuits or other hardware logic, and such resources can provide some or all of the housing sensor logic (see also housing sensor logic 135 of FIG. 1). For example, integrated circuits of the housing sensor component 240 can monitor for touch input and/or process the touch input as being of a particular kind. In variations, some or all of the housing sensor logic 211 is implemented with the processor 210 (which utilizes instructions stored in the memory 250), or with an alternative processing resource.

In one implementation, the housing sensor logic 211 includes detection logic 213 and gesture detect logic 215. The detection logic 213 implements operations to monitor for the user contacting a surface of the housing coinciding with placement of the sensor. The gesture detect logic 215 detects and correlates a particular gesture (e.g., user pinching corner, swiping, tapping etc.) as a particular type of input or user action. The gesture detect logic 215 can also detect aspects of the user contact, including directionality (e.g., up or down, vertical or lateral), gesture path, finger position, and/or velocity.

In one embodiment, the processor 210 uses housing sensor logic 211 to respond to input 231, and further responds to the input by providing a panel overlay over an existing content region. By way of example, the input 231 can correspond to a gesture or swipe detected through a housing sensing region 132 (see FIG. 1). In one implementation, a dedicated panel 219 is triggered and displayed over a content region in response to the input 231. In another implementation, the processor 210 uses gesture logic 215 to interpret the input 231, and then selects or configures content of the panel 219 based on aspects of the input 231. In particular, the gesture logic 215 can interpret the input based on aspects of the input 231 that include, for example, motion of a gesture, velocity of a swipe, or position of a finger over a given duration.

e-Book Housing Configurations

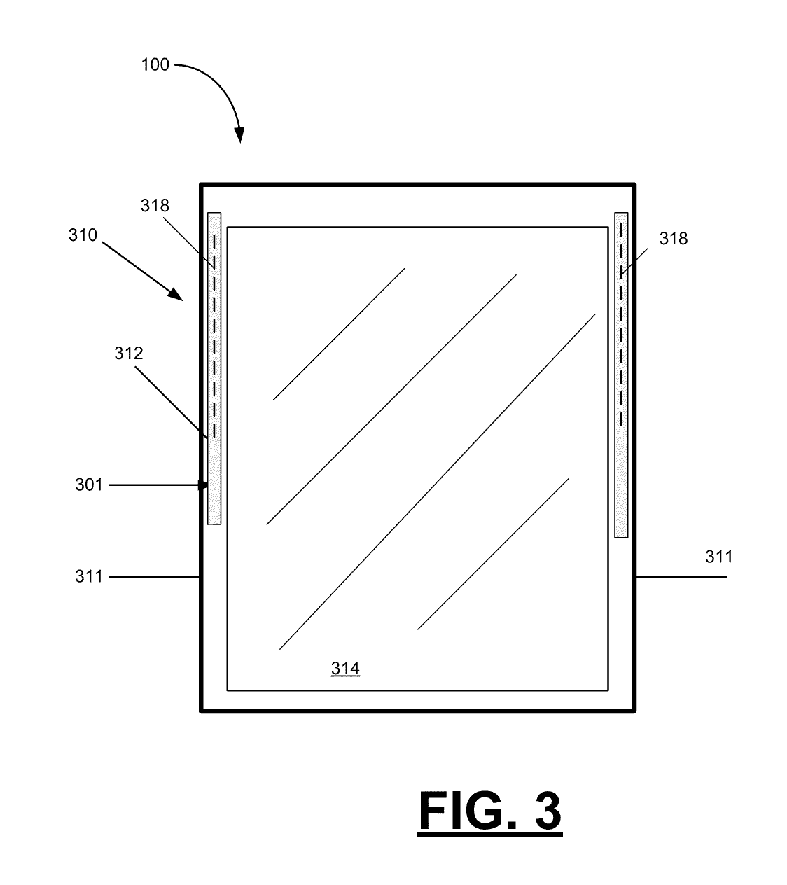

FIG. 3 is a frontal view of e-reader device 100, according to an embodiment. The e-reader device 100 includes a housing 310 having a front bezel 312 and a display screen 314. The e-reader device 100 can be substantially tabular or rectangular, so as to have a front surface 301 that is substantially occupied by the display screen 314 so as to enhance content viewing. The display screen 314 can be part of a display assembly, and can be touch sensitive. For example, the display screen 314 can be provided as a component of a modular display assembly that is touch-sensitive and integrated with housing 310 during a manufacturing and assembly process.

According to examples described herein, the e-reader device 100 includes one or more housing sensing regions 318 distributed at various locations of the housing 310. The housing sensing regions 318 can coincide with the integration of touch-sensors 328 with the housing 310. While an example of FIG. 3 provides for discrete sensing regions 318 provided at or near the sides 311 (or sidewalls) of the housing 310, variations can provide for a portion or even all of the surface area of the housing 310 to be integrated with touch-sensors 328 in order to enable touch-sensitivity form the device at any location of, for example, the front surface 301 and/or back surface (not shown). Furthermore, while an example of FIG. 3 illustrates sensing regions 318 at or near the sides 311, variations can provide for more or fewer sensing regions 318. For example, sensing regions 318 can be provided along the front façade or at a bezel region 312 of the front surface 301.

According to embodiments, the e-reader device 100 can integrate one or more types of touch-sensitive technologies in order to provide touch-sensitivity on both housing sensing regions 318 and on the display screen 314. It should be appreciated that a variety of well-known touch sensing technologies may be utilized to provide touch-sensitivity at either the sensing regions 318 or on the display screen 314. By way of example, touch-sensors 328 used with each of the sensing regions 318 or display screen 314 can utilize resistive touch sensors; capacitive touch sensors (using self and/or mutual capacitance); inductive touch sensors; or infrared touch sensors. For example, sensing regions 318 can be employed using resistive sensors, which can respond to pressure applied to the front surface 301 in areas coinciding with the sensing regions 318. In a variation, the sensing regions 318 can be implemented using a grid pattern of electrical elements which detect capacitance inherent in human skin. Alternatively, sensing regions 318 can be implemented using a grid pattern of electrical elements which are placed on or just beneath the front surface 301, and which deform sufficiently on contact to detect touch from an object such as a finger. More generally, touch-sensing technologies for implementing the sensing region 318 (or display screen 314) can employ resistive touch sensors, capacitive touch sensors (using self and/or mutual capacitance), inductive touch sensors, or infrared touch sensors.

In some embodiments, the sensors 328 can detect directionality in the touch input, and further distinguish directionality (e.g., up or down, lateral). Additionally, in some variations, the sensing regions 318 (as well as the display screen 314) can be equipped to detect multiple simultaneous touches. For example, with reference to an example of FIG. 3, a processor of the e-reader device 100 can process input from the sensing regions 318 in order to be responsive to (or distinctly detect) simultaneous user touch on both the front surface 301 and back surface (not shown). For example, the user can pinch a corner of the e-reader device 100 as a form of input. In such an example, the pinch can be interpreted as a specific type of input (e.g., swipe (including fast or slow swipe), tap (or multi-tap), mufti-touch pinch etc.) or as a general input (e.g., housing touched).

Panel Functionality

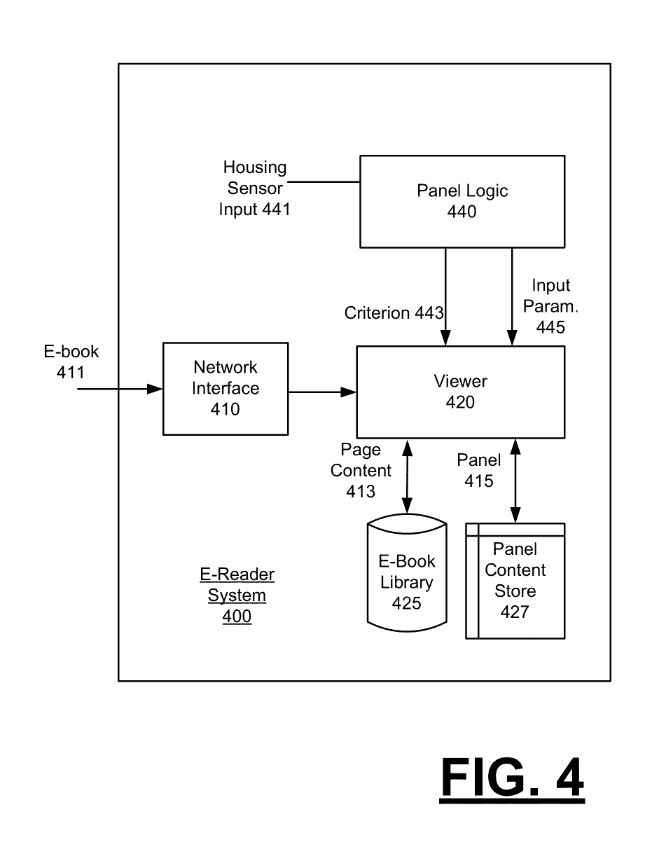

FIG. 4 illustrates an e-reader system for displaying a panel over a content region of a display screen in connection with touch input provided on a housing of a personal display device, according to one or more embodiments. An e-reader system 400 can be implemented as for example, an application or device, using components that execute on, for example, an e-reader device such as shown with examples of FIG. 1, FIG. 2 or FIG. 3. Furthermore, an e-reader system 400 such as described can be implemented in a context such as shown by FIG. 1, and configured as described by an example of FIG. 2 and FIG. 3.

In an example of FIG. 4, a system 400 includes a network interface 410, a viewer 420 and panel logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reader device (e.g., see memory 250 of e-reader device 100).

The viewer 420 can access page content 413 from a selected e-book, provided with the e-book library 425. The page content 413 can correspond to one or more pages that comprise the selected e-book. The viewer 420 renders one or more pages on a display screen at a given instance, corresponding to the retrieved page content 413.

The panel logic 440 can be provided as a feature or functionality of the viewer 420. Alternatively, the panel logic 440 can be provided as a plug-in or as independent functionality from the viewer 420. The panel logic 440 can be responsive to input detected through a touch sensing region of the housing (“housing sensor input 441”). In response to housing sensor input 441, panel logic 440 can trigger the viewer 420 into retrieving a panel 415 from a panel content store 427. The panel content store 427 can retain objects, or one or more pre-determined panels with a set of pre-determined objects. In one implementation, the objects provided with panels (or pre-determined panels) can correspond to interactive elements that can receive user selection and other input.

In one implementation, the viewer 420 can retrieve a pre-determined panel 415 from the panel store 427. In a variation, the viewer 420 can select objects and other panel content from the panel content store 415, and then present the particular objects and/or panel content as the panel 415. Still further, the viewer 420 can retrieve a panel framework from the panel content store 427, then populate the panel framework with other content, such as paginated content from a given e-book that is being viewed, or from an auxiliary resource of the e-book being viewed (e.g., dictionary).

In one implementation, the panel logic 440 can specify criterion 443 for selecting a panel (from a set of multiple possible panels), or for selecting objects that are to comprise the panel. As a variation, the panel logic 440 can specify with the criterion 443 what panel content to include with a panel framework. The criterion 443 can be based at least in part on one or more aspects of the housing sensor input 441. For example, in one embodiment, the panel logic 440 interprets housing sensor input 441 as a particular gesture from a set of possible gestures, then selects the panel (or panel objects) based on the identified gesture. Alternatively, aspects such as velocity or position of the housing sensor input 441 can determine the selected panel or panel objects.

In variations, the viewer 420 can generate or augment the criterion 443 based on other signals, such as context (e.g., what e-book is being viewed). For example, the viewer 420 can generate independent criterion for selecting the panel or panel objects.

The viewer 420 can display the panel 427 concurrently with the page content 413. In one aspect, the viewer 420 overlays or superimposes the panel 415 on the page content 413. The viewer 420 can also implement logic relating to the manner in which the panel 415 is displayed, including logic to (i) determine what portion of the panel 415 to display, (ii) what portion of the page content 413 to occlude with the portion of the panel 415, and/or (iii) the manner in which the panel 415 is to transition into superimposing or overlaying the page content 413. In this regard, the viewer 420 can receive input parameters 445 from the panel logic 420. The input parameters 445 can identify aspects of the housing sensing input 441, including one or more of: directionality (e.g., 2-directions, 4-directions), gesture characteristic (e.g., swipe versus tap or pinch), swipe length, finger position (sampled over a duration when the finger is in contact with the housing), and/or swipe or motion velocity. The input parameters 445 can affect how much of the panel 415 is displayed or how much of the page content 413 is occluded, and/or the manner (e.g., speed) in which the panel 415 is superimposed over the content region. The viewer 420 can also receive the input parameter 445 (or use context) in order to determine the nature of the transition during which the panel is brought in view. For example, as described with FIG. 7, the panel 415 can be presented as a shade that is slid over the page content 413. This visual effect can be generated in response to a particular aspect of the housing sensing input 441. In a variation, the panel 415 can be presented by, for example, transitioning the panel 415 from translucent to opaque, or some other visual effect.

By way of example, the panel logic 440 can detect one or more aspects about the housing sensor input 441, and then signal the viewer 420 to display the panel 415 in a manner that reflects a characteristic that reflects the detected aspect. In one embodiment, the housing sensor input 441 corresponds to a swipe, and the detected aspect can correspond to a location of the finger (or object making contact) along the swipe trajectory. The panel logic 440 reflects the position of the finger in relation to an area of the panel (e.g., area of panel increases with movement of finger in downward direction) or to a particular boundary of the panel (e.g., bottom boundary of panel moves with finger during swipe). In this way, the user can enter, for example, a slow swipe in order to cause the viewer to draw panel 415 slowly over an existing content region.

Still further, the panel logic 440 can detect a characteristic that corresponds to touch velocity (e.g., how fast user swipes). The panel logic 440 can signal the viewer 420 to draw panel over the content region in a speed that is based at least in part on the detected velocity. Still further, the panel logic 440 can detect a particular path or gesture from the housing sensor input 441, and then configure or select the panel content for the panel 415 based on the gesture or path.

Methodology

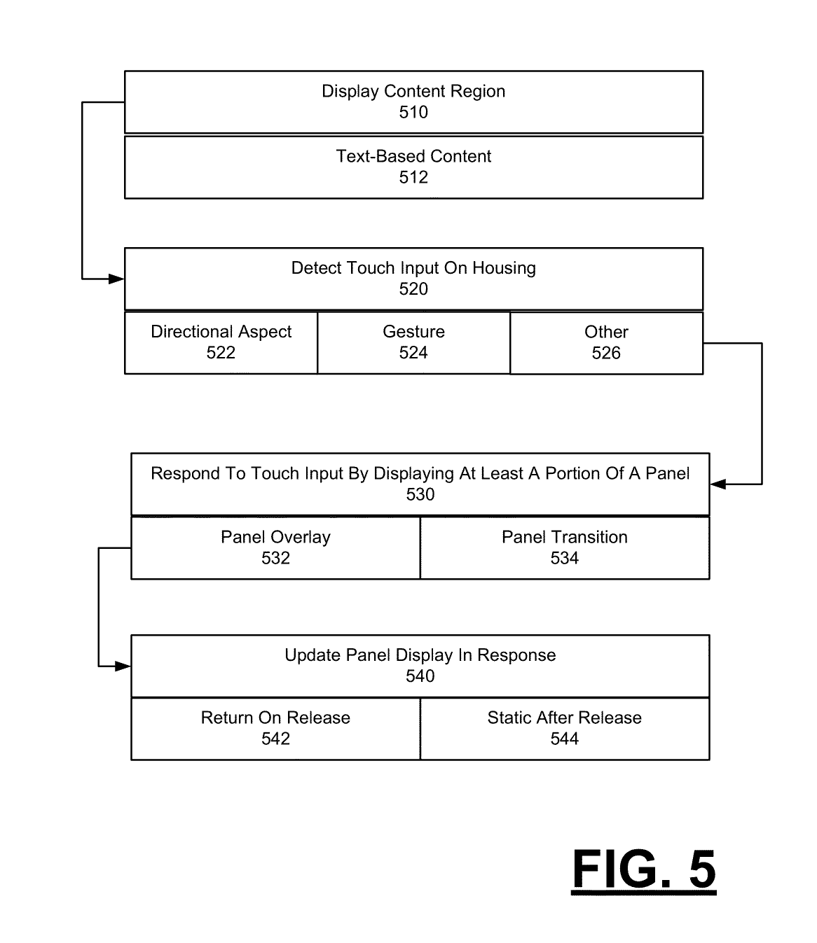

FIG. 5 illustrates a method for displaying a panel overlay responsive to touch input, according to one or more embodiments. In describing an example of FIG. 5, reference may be made to components such as described with FIG. 4 for purpose of illustrating suitable components for performing a step or sub-step being described.

With reference to an example of FIG. 5, the viewer 420 displays a content region (510). For example, the viewer 420 can display a single page corresponding to a text-based content (512), such as a page being read by the user, or alternatively, display multiple pages side-by-side to reflect a display mode preference of the user. Alternatively, the content region can correspond to some other form of content, such as an image or media presentation.

A touch input (e.g., housing sensor input 441) can be detected on a housing of the display (520). In particular, the touch input can be detected with touch sensors that are embedded or integrated into the housing of the device (rather than the display surface). The panel logic 440 can detect one or more aspects about the housing sensor input 441 (520). In particular, the panel logic 440 can detect a directional aspect of the input (522). The directional aspect can correspond to, for example, whether the input is vertical (or along a length of the housing), sideways (along a lateral edge extending from sidewall to sidewall), whether the input is downward, or whether the input is upward. As an alternative or variation, the panel logic 440 can detect whether the housing sensor input 441 is a gesture (e.g., pinch, tap, mufti-tap) (524). The housing sensor input 441 can include logic to interpret the gesture. In variations, other aspects can also be detected (526), such as velocity or positioning of the finger (or other contact object) as a given moment.

In response to the panel logic 440 detecting the housing sensing region input 441, the viewer 420 can trigger display of at least a portion of a panel 415 (530). In one example, the portion of the panel 415 is displayed as an overlay (532). For example, a portion of the panel 415 can be overlaid over the content region (e.g., page content 413) so as to occlude a portion of the page content. Depending on implementation, the panel 414 can be partially translucent or opaque.

In another example, the viewer 420 can also implement a panel transition visual effect where the panel 415 is drawn relative to the page content 413 (534). For example, the panel 415 can be made to visually slide down like a shade. Aspects such as velocity of the panel transition into view can be pre-determined, or alternatively based on signals such as the housing sensing input 441.

The display of the panel 415 can be updated based on housing sensor input 441 (540). For example, the content of the panel 415 can be changed based on user input or interaction or the passage of time. As an addition or alternative, the transition of the panel 415 from a partial to fully displayed state can also be completed. By way of example, the panel 415 can be returned (e.g., visually made to appear) upon release or cessation of the housing sensor input 441 (542). As an alternative or variation the panel 415 can remain static after release or cessation of the housing sensor input 441 (544). For example, the panel 415 can remain in a static and displayed state until additional input is received to eliminate or otherwise alter the panel.

FIG. 6A through FIG. 6C illustrate examples of display states of a screen for a personal display device, in accordance with one or more embodiments. In examples of FIG. 6A through FIG. 6C, a personal display device 600 includes a housing 608 and a display screen 612. The personal display device 600 can include, for example, a sensor configuration similar to that provided in an example of FIG. 3. In an initial state (FIG. 6A), the personal display device 600 can display a content screen 610, corresponding to, for example, a page of an e-book.

As shown by an example of FIG. 6B, in response to a housing sensor input 601, the personal display device 600 can initiate displaying a panel 620. In the example of FIG. 6B, the panel 620 can be predetermined or designated. Additionally, the panel 620 is drawn to substantially (e.g., more than 80%) match a width of the display screen. Still further, in one implementation, the panel 620 can provide input functionality, such as features 622 that can be selected by the user for purpose of entering input. By way of example, the panel 620 can correspond to a home screen. The home screen can reflect a default interface that can be retrieved to provide basic application or device functionality. The home screen can provide a mechanism for a user to, for example, pause an interaction with a particular application or application resource (e.g., e-book), and perform some other operation requiring functionality or resources of another application or application resource.

In an example of FIG. 6B, when the panel 620 is triggered into display, it is transitioned into view. By way of example, the panel 620 can appear to slide down from an invisible state that is at the top edge of the display screen 612. In one implementation, a lower boundary 621 of the panel 620 coincides in position with a position of the contact for input 601 (represented by the tip of the arrow 601).

FIG. 6C illustrates a state where the panel 620 is more revealed. In an example, as the panel 620 is slid down, more aspects of the panel are revealed or made viewable (e.g., interface feature 624). At the same time a larger portion of the content screen 610 is hidden by the panel's overlay. In the example provided, the lower boundary 621 of the panel 620 can be brought down to match the user contact. Thus, in the example provided, the user can move his finger up or down to, for example, cause the bottom boundary 621 to move up or down. The movement of the boundary 621 can in turn affect how much of the panel 620 is displayed.

FIG. 7 illustrates an example of an e-book device that is operated by the user to trigger a panel display that overlays an e-book page. An example of FIG. 7 can be implemented using an e-book device such as described with examples of FIG. 1 through FIG. 5. An e-reader device 700 can include a housing 710 and a display 712. In an example provided, each of the housing 710 and display 712 are touch-sensitive. Thus, for example, the e-book device can include a housing configuration such as shown with an example of FIG. 3.

At a given moment, the display 712 can be used to render a particular page 715 of an e-book. In an example of FIG. 7, the user can perform an action corresponding to a vertical swipe down a sidewall 711 of the housing. In response to the swipe, a panel 725 can be drawn to overlay the page 715. The panel 725 can partially occlude the page 715, and provide functionality such as e-book library or download functionality. Further, in the example provided, the panel 725 can be interactive, or include interactive elements that are selectable by the user. Additionally, in the example provided, the contents of the panel 725 can be dynamic and determined based on context, such as what e-book the user has stored on his device or associated with his account.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a housing;
a display assembly including a display screen;
a touch sensor provided within a portion of the housing;
wherein the housing at least partially circumvents the screen so that the screen is viewable;
a processor provided within the housing, the processor operating to:
display a content region on the display screen; and
respond to touch input, detected through the touch sensor within the portion of the housing, by overlaying a panel over at least a portion of the content region.

2. The computing device of claim 1, wherein the processor detects a directional aspect of the touch input, and configures the panel based on the detected directional aspect.

3. The computing device of claim 1, wherein the processor detects a directional aspect of the touch input, and selects a content for the panel based on the detected directional aspect.

4. The computing device of claim 1, wherein the panel occupies at least a substantial width of the display screen and includes a dedicated set of user-interface features.

5. The computing device of claim 1, wherein the processor detects an aspect of the touch input, and displays at least the portion of the panel with a characteristic that is based on the detected aspect of the touch input.

6. The computing device of claim 5, wherein the processor detects an aspect of the touch input as being one of (i) a direction of the touch input, (ii) a location of the touch input at multiple locations over a given duration, and/or (iii) a swipe speed of the touch input.

7. The computing device of claim 1, wherein the processor detects an aspect of the touch input by interpreting the touch input as being a particular gesture from a set of possible gestures.

8. The computing device of claim 7, wherein the processor responds to the touch input by transitioning at least the portion of the panel into overlaying the content region.

9. The computing device of claim 1, wherein the processor responds to the touch input by directionally transitioning the panel over at least the portion of the content region so as to simultaneously reveal more of the panel while concealing more of the content region.

10. The computing device of claim 1, wherein the panel includes selectable display features.

11. The computing device of claim 1, wherein the panel is a home screen with multiple selectable features.

12. The computing device of claim 1, wherein the display assembly is touch-sensitive, and wherein at least one of the content region or panel provides display features which are responsive to touch input.

13. The computing device of claim 1, wherein the touch sensor is provided along a length of a sidewall of the housing.

14. A method for operating a computing device, the method being implemented by one or more processors and comprising:
displaying content in form of a content region on a display screen of the computing device; and
responding to touch input detected through a touch sensor mechanism of a housing of the computing device, by overlaying at least a portion of a panel over a portion of a content region.

15. The method of claim 14, further comprising detecting a directional aspect of the touch input, and configuring the panel based on the detected directional aspect.

16. The method of claim 14, further comprising detecting a directional aspect of the touch input, and selecting a content for the panel based on the detected directional aspect.

17. The method of claim 14, further comprising transitioning at least the portion of the panel into overlaying the content region in response to the touch input.

18. The method of claim 17, wherein transitioning at least the portion of the panel includes directionally transitioning the panel over at least the portion of the content region so as to simultaneously reveal more of the panel while concealing more of the content region.

19. The method of claim 14, wherein the panel includes selectable display features.

20. A non-transitory computer-readable medium that stores instructions, that when executed by one or more processors, cause the one or more processors to perform operations that include:
displaying content in form of a content region on a display screen of the computing device; and
responding to touch input detected through a touch sensor mechanism of a housing of the computing device, by overlaying at least a portion of a panel over a portion of a content region.
